(19) United States
(12) Patent Application Publication
(10) Pub. No.: US 2005/0008331 A1
(43) Pub. Date: Jan. 13, 2005

(54) Dynamic image decoding device

(75) Inventors: Kengo Nishimura, Osaka (JP); Yoriko Yagi, Kyoto (JP); Michihiro Matsumoto, Hyogo (JP); Takaharu Morohashi, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/863,483

(22) Filed: Jun. 9, 2004

(30) Foreign Application Priority Data
Jun. 9, 2003 (JP) 2003-163170

(51) Int. Cl. H04N 5/783; H04B 1/66

(52) U.S. Cl. 386/68; 386/111

(57) ABSTRACT

A dynamic image decoding device of the invention is a device for decoding encoded dynamic image data. The dynamic image decoding device has an ordinary reproducing mode and a rewind reproducing mode. The dynamic image decoding device includes an analysis unit, a decoding unit and an output unit. The analysis unit selects at least one of a plurality of difference frames. The decoding unit decodes the difference frame selected by the analysis unit, a first reference frame and a second reference frame. The output unit outputs, to a display device, the difference frame, the first reference frame and the second reference frame having been decoded by the decoding unit successively in the order from one present more ahead on the time axis, namely, in the order of the second reference frame, the difference frame and the first reference frame, on the basis of frame information in the rewind reproducing mode.

### BACKGROUND OF THE INVENTION

The present invention relates to a device for decoding encoded dynamic image data, and more particularly, it relates to control of rewind reproducing processing for encoded dynamic image data.

Today, owing to development of information technology, voice and dynamic images (video) compressed and stored in a storage medium in accordance with the MPEG standard or the like can be reproduced for amusement. The MPEG standard is an encoding standard for encoding dynamic image data as a reference frame and a difference frame. In a dynamic image decoding device for decoding and displaying the encoded dynamic image data having such a data structure, in order that a user can easily and rapidly retrieve contents, it is significant to support special reproducing processing such as fast-forward and rewind in accordance with an instruction made by the user. For dynamic image compressed in accordance with the MPEG standard, a dynamic image decoding device capable of coping with a bit rate higher than an average bit rate of dynamic image data is necessary for rapid display, which is unpreferable also from the viewpoint of cost. Therefore, there has been a demand for a method for performing special reproducing processing with a display bit rate kept constant.

Conventionally, in rewind reproducing processing of a dynamic image decoding device, reference frames alone, out of encoded dynamic image data compressed in accordance with the MPEG standard, are decoded, so as to display the decoded reference frames in the order from one present more ahead on the time axis.

### SUMMARY OF THE INVENTION

When the reference frames alone are displayed, however, difference frames present between the reference frames are skipped in the display, and hence, it is difficult to produce smooth rewind reproduced display.

Furthermore, in the case where the interval between the reference frames is long and a large number of difference frames are present between the reference frames, the number of difference frames skipped in the rewind reproduced display is so large that it is difficult for a user to retrieve a desired frame.

An object of the invention is providing a dynamic image decoding device capable of producing smooth rewind reproduced display.

The dynamic image decoding device of this invention is a device for decoding encoded dynamic image data. The encoded dynamic image data includes frame information, a first reference frame, a second reference frame and a plurality of difference frames. The frame information includes information of arrangement on the time axis of frames included in the encoded dynamic image data. The first reference frame is data resulting from intraframe prediction coding. The second reference frame is data resulting from intraframe prediction coding and present ahead of the first reference frame on the time axis. The plural difference frames are data present between the first reference frame and the second reference frame on the time axis and resulting from the interframe prediction coding on the basis of the first reference frame. The dynamic image decoding device has an ordinary reproducing mode and a rewind reproducing mode. The dynamic image decoding device includes an analysis unit, a decoding unit and an output unit. The analysis unit selects at least one of the plurality of difference frames. The decoding unit decodes the difference frame selected by the analysis unit and the first and second reference frames. The output unit outputs, to a display device, the difference frame, the first reference frame and the second reference frame having been decoded by the decoding unit successively in an order from one present more ahead on the time axis, namely, in the order of the second reference frame, the difference frame and the first reference frame, on the basis of the frame information.

In the rewind reproducing mode of the dynamic image decoding device, at least one difference frame is inserted between the second reference frame and the first reference frame to be output to the display device. Therefore, the number of frames to be output to the display device is larger than in the case where decoded reference frames alone are output. As a result, smoother rewind reproduced display can be produced as compared with the case where the reference frames alone are selected to be displayed.

Preferably, the dynamic image decoding device further includes a separation unit, which separates the encoded dynamic data from AV data. In the AV data, the encoded dynamic image data is multiplexed in accordance with a given file format (a multiplex standard).

Preferably, the given file format is ASF or MP4.

Preferably, the analysis unit selects at least one of difference frames that are able to be decoded on the basis of the first reference frame within timing of output from the output unit to the display device in the rewind reproducing mode.

Even when a difference frame is decoded by the decoding unit in the rewind reproducing mode, if the difference frame cannot be completed in decoding by timing for outputting it to the display device, the difference frame cannot be output to the display device. In other words, in some cases, although the difference frame has been decoded by the decoding unit, the difference frame cannot be output by the output unit, and hence, smooth rewind reproduced display cannot be produced.

Therefore, in the dynamic image decoding device, the analysis unit selects, from difference frames decoded on the basis of the first reference frame, at least one difference frame that can be completed in decoding earlier than the timing for outputting it to the display device.

Preferably, the dynamic image decoding device further includes a buffer, which stores a difference frame having been decoded by the decoding unit. The output unit outputs, to the display device, the difference frame stored in the buffer and the first and second reference frames having been decoded by the decoding unit successively in the order from one present more ahead on the time axis on the basis of the frame information in the rewind reproducing mode.

In the case where the processing speed of the decoding unit is higher than the processing speed of the output unit, the decoding unit should wait for the complete of the processing of the output unit. Accordingly, the processing of the decoding unit may be delayed in some cases.

In the dynamic image decoding device, however, after storing the decoded dynamic image data having been decoded by the decoding unit, the buffer delivers the decoded dynamic image data to the output unit. Thus, the processing speed of the decoding unit and the processing speed of the output unit are buffered by the buffer between the decoding unit and the output unit. Thus, the processing of the decoding unit can be performed without delay.

Preferably, the decoding unit stores a difference frame selected by the analysis unit out of difference frames decoded in the ordinary reproducing mode.

In the rewind reproducing mode of the dynamic image decoding device, the decoding unit decodes the reference frames alone without decoding difference frames. The output unit outputs the decoded reference frames obtained by the decoding unit and the difference frame stored in the buffer.

In this manner, in the dynamic image decoding device, the decoding unit need not decode difference frames but decodes reference frames alone in the rewind reproducing mode. Therefore, smooth rewind reproduced display can be produced with the processing burden reduced.

Preferably, the decoding unit decodes a second difference frame on the basis of the difference frame stored in the buffer. Also, the output unit outputs, to the display device, the difference frame stored in the buffer, the second difference frame and the first and second reference frames having been decoded by the decoding unit successively in the order from one present more ahead on the time axis on the basis of the frame information in the rewind reproducing mode.

In the rewind reproducing mode of the dynamic image decoding device, the decoding unit decodes another difference frame on the basis of the difference frame stored in the buffer. Therefore, the number of frames to be output by the output unit is increased as compared with the case such decoding processing is not performed. Also, in the case where the number of difference frames to be output to the display device is the same, the number of difference frames to be stored in the buffer can be reduced as compared with the case where such decoding processing is not performed.

In this manner, in the dynamic image decoding device, the number of frames to be output to the display device can be increased, and hence, smooth rewind reproduced display can be produced. Alternatively, the memory capacity of the buffer can be reduced because the number of difference frames to be stored in the buffer is reduced.

Preferably, the encoded dynamic image data further includes a third reference frame and a plurality of difference frames. The third reference frame is data resulting from intraframe prediction coding and present behind the first reference frame on the time axis. The plurality of difference frames are data present between the third reference frame and the first reference frame on the time axis and resulting from interframe prediction coding on the basis of the third reference frame. The analysis unit selects at least one of the plurality of difference frames present between the third reference frame and the first reference frame. The decoding unit decodes the difference frame having been selected by the analysis unit (namely, the difference frame present between the third reference frame and the first reference frame) in parallel to the output of frames from the output unit to the display device.

In the dynamic image decoding device, the decoding unit decodes a difference frame necessary for the output unit to output to the display device next (that is, a difference frame selected by the decoding unit and present between the third reference frame and the first reference frame) in parallel to the output of the frames from the output unit to the display device. Therefore, the number of difference frames previously stored in the buffer can be reduced as compared with the case where such parallel decoding is not performed.

In this manner, in the dynamic image decoding device, the memory capacity of the buffer can be reduced because the number of difference frames to be stored in the buffer is reduced.

Preferably, the decoding unit stores, in the buffer, the decoded difference frame with resolution thereof lowered. The output unit expands the difference frame stored in the buffer to be output to the display device.

In the dynamic image decoding device, the decoding unit stores, in the buffer, the decoded difference frame with its resolution lowered. Therefore, the buffer can store a larger number of difference frames as compared with the case where the resolution is not lowered. The output unit can output a larger number of frames to the display device as compared with the case where the resolution is not lowered. In this case, although the display is disturbed, a frame desired by a user can be more highly possibly displayed in the rewind reproducing mode because the number of frames to be displayed is increased. Thus, the user can easily retrieve a desired scene of the dynamic image.

Preferably, the decoding unit stores, in the buffer, the decoded difference frame with resolution thereof lowered. The output unit expands the difference frame stored in the buffer and the second difference frame having been decoded by the decoding unit to be output to the display device.

In the dynamic image decoding device, the decoding unit stores, in the buffer, the difference frame with its resolution lowered in the ordinary reproducing mode. Then, in the rewind reproducing mode, the decoding unit decodes a second difference frame on the basis of the difference frame stored in the buffer. The second difference frame decoded on the basis of the difference frame stored in the buffer has lowered resolution. When the output unit outputs the frames having been decoded by the decoding unit, it expands the frames with the lowered resolution to be output to the display device. Therefore, as compared with the case where the second difference frame is not decoded, although the display is disturbed, the number of frames to be displayed is increased, and hence, a frame desired by a user is more highly possibly displayed in the rewind reproducing mode. Thus, the user can easily retrieve a desired scene in the dynamic image.

Preferably, the decoding unit stores, in the buffer, the decoded difference frame with resolution thereof lowered. Also, the decoding unit expands the difference frame stored in the buffer and decodes another difference frame by using the expanded difference frame.

In the dynamic image decoding device, the decoding unit stores, in the buffer, a difference frame with its resolution lowered in the ordinary reproducing mode. Then, in the rewind reproducing mode, the decoding unit expands the difference frame stored in the buffer, and decodes another difference frame on the basis of the expanded difference frame. The latter difference frame having been decoded on the basis of the expanded difference frame has lowered resolution. The output unit outputs these difference frames having been decoded by the decoding unit. Therefore, as compared with the case where another difference frame is not decoded, although the display is disturbed, a frame desired by a user is more highly possibly displayed in the rewind reproducing mode. Thus, the user can easily retrieve a desired scene in the dynamic image.

Preferably, when the rewind reproducing mode is switched to the ordinary reproducing mode, the decoding unit redecodes a difference frame displayed at mode switching on the basis of a reference frame used correspondingly for decoding the difference frame.

When a difference frame with lowered resolution is displayed on the display device in the rewind reproducing mode, if the rewind reproducing mode is switched to the ordinary reproducing mode, the decoding of the currently displayed difference frame is performed not on the basis of the first reference frame but on the basis of the difference frame with the lowered resolution displayed on the display device. Therefore, difference frames to be decoded thereafter have lowered resolution, and hence, the ordinary reproducing processing is performed with the display disturbed.

In contrast, in the dynamic image decoding device, when the rewind reproducing mode is switched to the ordinary reproducing mode, the decoding unit redecodes the difference frame displayed on the display device on the basis of the first reference frame. Therefore, the difference frame displayed on the display device recovers its original resolution. As a result, the ordinary reproducing processing can be performed without disturbing the displayed image.

In the dynamic image decoding device of this invention, in the rewind reproducing processing for encoded dynamic image data having been encoded in accordance with the MPEG standard, differently from the conventional technique in which reference frames alone are displayed, a difference frame present between the reference frames is selected, data up to the selected difference frame is decoded or previously stored, so that smooth rewind reproduced display can be produced.

### BRIEF DESCRIPTION OF THE DRAWINGS

FIG. 1 is a block diagram for showing the whole architecture of a dynamic image reproducing system according to Embodiment 1 of the invention;

FIG. 2 is a flowchart for showing procedures in ordinary reproducing processing performed in the dynamic image reproducing system of FIG. 1;

FIG. 3 is a diagram of an example of multiplex data;

FIG. 4 is a diagram of an example of encoded dynamic image data;

FIG. 5 is a diagram of an example of frame information;

FIG. 6 is a flowchart for showing procedures in rewind reproducing processing performed in the dynamic image reproducing system of FIG. 1;

FIG. 7 is a diagram of an exemplified procedure for calculating a limit number m of selectable difference frames employed in FIG. 6;

FIG. 8 is a diagram of an exemplified procedure for decoding encoded dynamic image data employed in FIG. 6;

FIG. 9 is a diagram of an exemplified procedure for storing decoded dynamic image data in a frame buffer employed in FIG. 6;

FIG. 10 is a diagram of an exemplified procedure for outputting the decoded dynamic image data stored in the frame buffer to a display device employed in FIG. 6;

FIG. 11 is a diagram for showing a specific example of the procedure for calculating the limit number m of the selectable difference frames employed in FIG. 6;

FIG. 12 is a diagram for showing an example of data change in FIG. 6;

FIG. 13 is a flowchart for showing procedures in ordinary reproducing processing performed in a dynamic image reproducing system according to Embodiment 2 of the invention;

FIG. 14 is a diagram for showing an example of data change in FIG. 14;

FIG. 15 is a flowchart for showing procedures in rewind reproducing processing performed in the dynamic image reproducing system according to Embodiment 2 of the invention;

FIG. 16 is a diagram for showing an example of data change in FIG. 15;

FIG. 17 is a flowchart for showing procedures in rewind reproducing processing performed in a dynamic image reproducing system according to Embodiment 3 of the invention;

FIG. 18 is a diagram for showing an example of data change in FIG. 17;

FIG. 19 is a flowchart for showing procedures in rewind reproducing processing performed in a dynamic image reproducing system according to Embodiment 4 of the invention;

FIG. 20 is a diagram for showing an example of data change in FIG. 19;

FIG. 21 is a flowchart for showing procedures in ordinary reproducing processing performed in a dynamic image reproducing system according to Embodiment 5 of the invention;

FIG. 22 is a flowchart for showing procedures in rewind reproducing processing performed in the dynamic image reproducing system according to Embodiment 5 of the invention;

FIG. 23 is a diagram for showing an example of data change in FIG. 22;

FIG. 24 is a flowchart for showing procedures in rewind reproducing processing performed in a dynamic image reproducing system according to Embodiment 6 of the invention;

FIG. 25 is a diagram for showing an example of data change in FIG. 24;

FIG. 26 is a flowchart for showing procedures in rewind reproducing processing performed in a dynamic image reproducing system according to Embodiment 7 of the invention;

FIG. 27 is a diagram for showing an example of data change in FIG. 26;

FIG. 28 is a flowchart for showing procedures in switching processing performed in a dynamic image reproducing system according to Embodiment 8 of the invention; and

FIG. 29 is a diagram for showing an example of data change in FIG. 28.

### DETAILED DESCRIPTION OF THE INVENTION

Now, preferred embodiments of the invention will be described in detail with reference to the accompanying drawings. It is noted that the same reference numerals are used in these drawings to refer to the same or corresponding elements so as to avoid repeating the description.

### EMBODIMENT 1

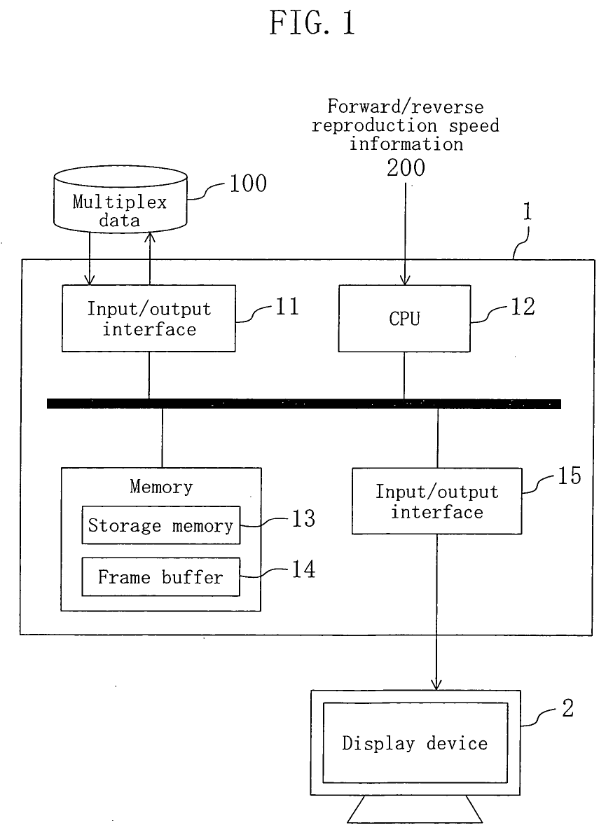

The whole architecture of a dynamic image reproducing system according to Embodiment 1 is shown in FIG. 1. This system performs reproducing processing (ordinary reproducing and special reproducing processing) for encoded dynamic image data included in multiplex data 100. This system includes a dynamic image decoding device 1 and a display device 2. The dynamic image decoding device 1 includes input/output interfaces 11 and 15, a CPU 12, a storage memory 13 and a frame buffer 14.

The input/output interface 11 performs input processing for the multiplex data 100 externally supplied.

The CPU 12 analyzes the multiplex data, acquires frame information, decodes encoded dynamic image data and controls the whole system in accordance with forward/reverse reproduction speed information 200. The forward/reverse reproduction speed information 200 corresponds to a reproducing direction and a reproduction speed specified by a user.

The storage memory 13 stores the multiplex data 100, the frame information and the encoded dynamic image data.

The frame buffer 14 stores decoded dynamic image data.

The input/output interface 15 outputs the decoded dynamic image data stored in the frame buffer 14 to the display device 2.

Now, the operation of the dynamic image reproducing system of FIG. 1 will be described. Herein, ordinary reproducing processing and rewind reproducing processing will be described.

[Ordinary Reproducing Processing]

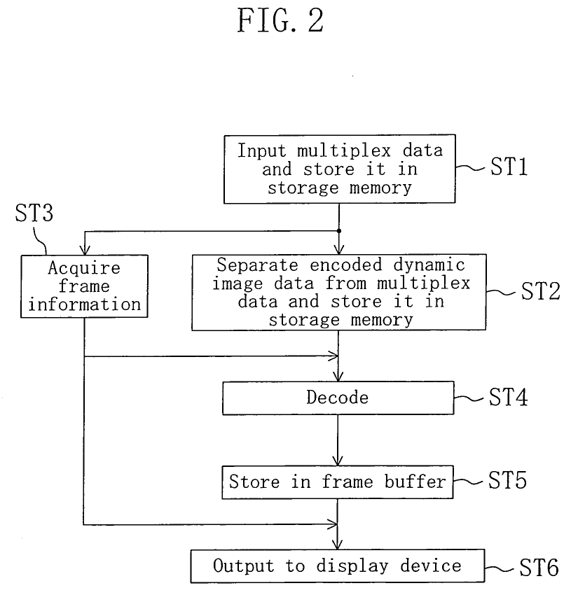

When the reproducing direction and the reproduction speed corresponding to the forward/reverse reproduction speed information 200 are respectively the forward direction and the standard speed, the dynamic image reproducing system enters an ordinary reproducing mode so as to perform the ordinary reproducing processing. The ordinary reproducing processing will now be described with reference to FIG. 2.

[Step ST1]

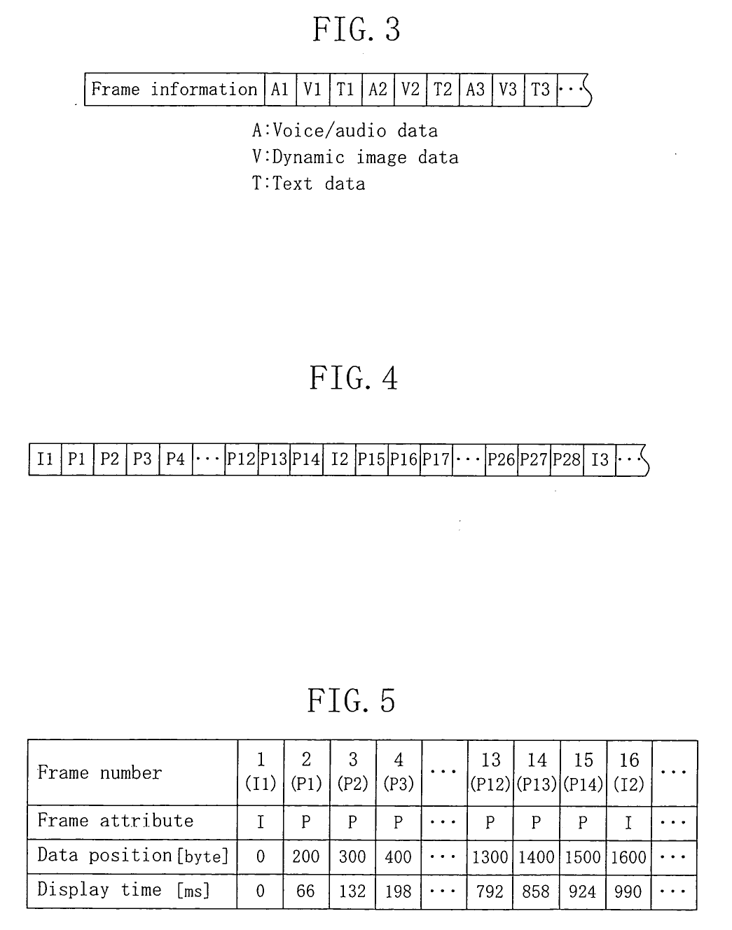

The multiplex data 100 is input through the input/output interface 11 to the dynamic image decoding device 1. An example of the multiplex data 100 is shown in FIG. 3. The multiplex data 100 is data (AV data) in which frame information, encoded dynamic image data, encoded voice/audio data, encoded text data and the like are multiplexed with respect to each frame in accordance with a multiplex standard (a file format) such as ASF and MP4.

[Step ST2]

Next, the CPU 12 separates encoded dynamic image data from the multiplex data 100. The separated encoded dynamic image data is stored in the storage memory 13. An example of the encoded dynamic image data is shown in FIG. 4. The encoded dynamic image data is encoded in accordance with the MPEG standard. The encoded dynamic image data includes reference frames I1, I2, etc. and difference frames P1, P2, etc. The reference frames I1, I2, etc. are data resulting from intraframe prediction coding. The difference frames P1, P2, etc. are data resulting from forward interframe prediction coding based on the reference frames I1, I2, etc. In the example shown in FIG. 4, the number of difference frames present between the reference frames is fourteen. The difference frames P1 through P14 are data resulting from the forward interframe prediction coding on the basis of the reference frame I1, and the difference frames P15 through P28 are data resulting from the forward interframe prediction coding on the basis of the reference frame I2.

[Step ST3]

Also, the CPU 12 acquires frame information from the multiplex data 100 and stores the acquired frame information in the storage memory 13. An example of the frame information is shown FIG. 5. The frame information includes a frame number, a frame attribute, a data position and a display time. The frame number, the frame attribute, the data position and the display time are provided to each frame included in the dynamic image data. The frame number indicates the number of the corresponding frame counted from the starting frame. The frame attribute indicates whether the corresponding frame is a reference frame (I) or a difference frame (P). The data position indicates the position (in which byte it is positioned from the start) of data of the corresponding frame. The display time corresponds to display timing information for AV synchronization designated as “Presentation Time Stamp (PTS)” and indicates time at which the corresponding frame is to be displayed. In the exemplified frame information shown in FIG. 5, a frame present further behind on the time axis has the display time with a smaller value and a frame present further ahead on the time axis has the display time with a larger value.

[Step ST4]

Next, the CPU 12 decodes the encoded dynamic image data stored in the storage memory 13. With respect to a reference frame, the frame data is decoded by using the encoded data alone. With respect to a difference frame, the frame data is decoded by using data of difference from previously decoded frame data.

[Step ST5]

The frame data decoded in step ST4 are successively stored in the frame buffer 14.

[Step ST6]

Next, the input/output interface 15 outputs the frame data stored in the frame buffer 14 to the display device 2 in the ascending order of the display times included in the frame information. The display device 2 displays the frame data supplied by the input/output interface 15 on its screen.

[Rewind Reproducing Processing]

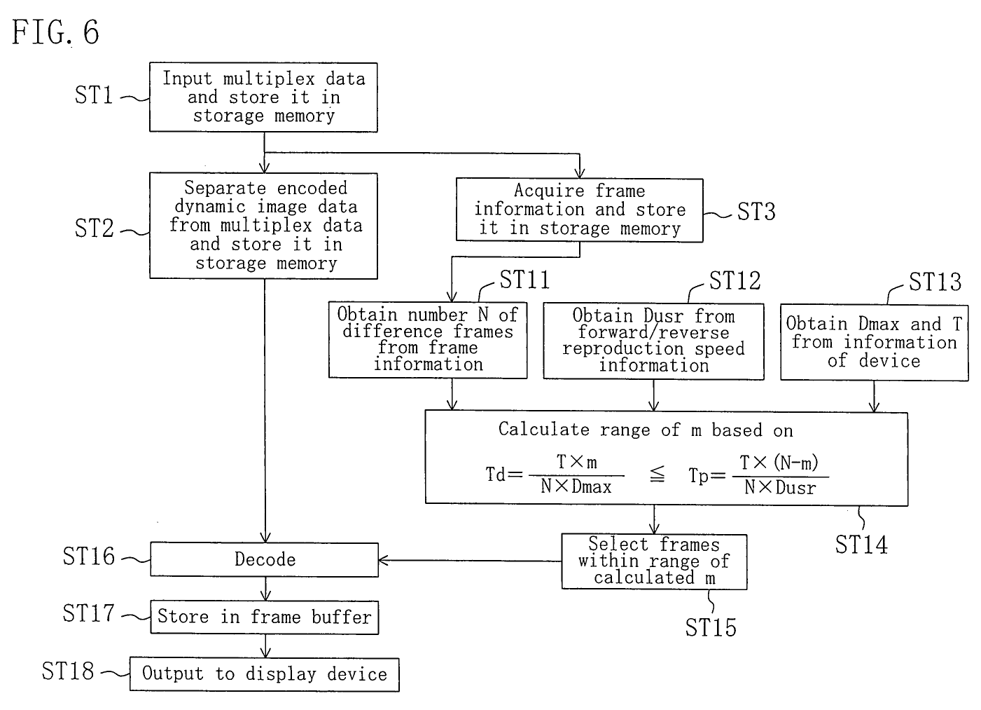

When the reproducing direction corresponding to the forward/reverse reproduction speed information 200 is the reverse direction, the dynamic image reproducing system enters a rewind reproducing mode so as to perform the rewind reproducing processing. Now, the rewind reproducing processing will be described with reference to FIG. 6.

[Step ST1]

The multiplex data 100 is input through the input/output interface 11 to the dynamic image decoding device 1.

[Step ST2]

Next, the CPU 12 separates encoded dynamic image data from the multiplex data 100 and the separated encoded dynamic image data is stored in the storage memory 13.

[Step ST3]

Also, the CPU 12 acquires frame information from the multiplex data 100 and stores the acquired frame information in the storage memory 13.

[Step ST11]

Next, the CPU 12 obtains a number N of difference frames present between reference frames by referring to the frame information stored in the storage memory 13.

[Step ST12]

Also, the CPU 12 acquires, from the forward/reverse reproduction speed information 200, a scale factor Dusr of a reproduction speed employed in the rewind reproducing processing against the standard reproduction speed.

[Step ST13]

Furthermore, the CPU 12 obtains a scale factor Dmax of a possible maximum decoding speed against a decoding speed employed in the ordinary reproducing processing of the dynamic image decoding device 1, and a time T required for decoding all of the N difference frames present between the reference frames at the decoding speed employed in the ordinary reproducing processing.

[Step S14]

Next, the CPU 12 calculates, on the basis of the information obtained from steps ST11 through ST13, a limit number m of difference frames that can be decoded in the rewind reproducing processing.

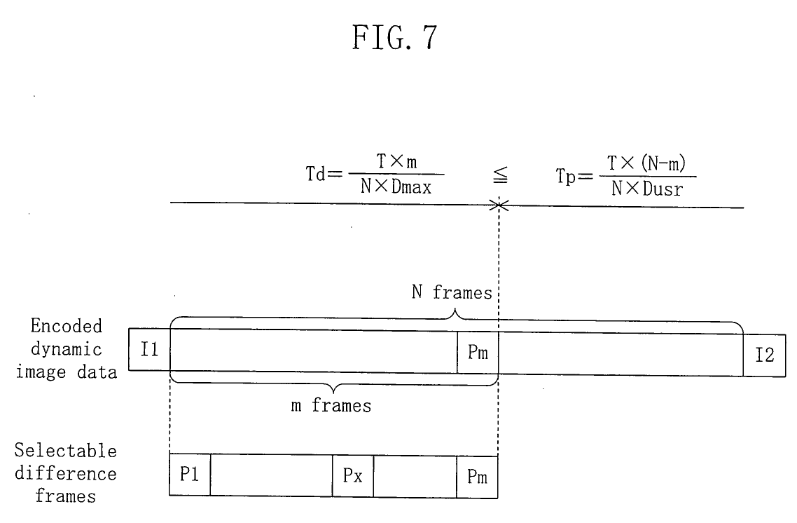

Now, the method for calculating the limit number m of difference frames that can be decoded in the rewind reproducing processing will be described with reference to FIG. 7.

It is herein assumed that a reference frame Pm present as the mth frame from a reference frame I1 is to be displayed next to a reference frame 12. A time Td necessary for actually decoding the difference frame Pm is represented by the following formula 1 by using the scale factor Dmax of the possible maximum decoding speed against the decoding speed employed in the ordinary reproducing processing of the dynamic image decoding device 1, the number N of difference frames present between the reference frames, the time T required for decoding all the N difference frames present between the reference frames at the decoding speed employed in the ordinary reproducing processing and the number m of the frames present from the reference frame I1 to the difference frame Pm to be specified:

$$Formula 1 \text{:}$$

$$Td = \frac{T \times m}{N \times D max}$$

Also, a time Tp from the display time of the reference frame I2 to the display time of the difference frame Pm in the rewind reproducing processing is represented by the following formula 2 by using the scale factor Dusr of the rewind reproduction speed specified by a user as the forward/reverse reproduction speed information 200 against the standard reproduction speed, the number N of the difference frames present between the reference frames, the time T required for decoding all the N difference frames present between the reference frames at the decoding speed employed in the ordinary reproducing processing and the number m of the frames present from the reference frame I1 to the difference frame Pm to be specified:

$$Formula 2 \text{:}$$

$$Tp = \frac{T \times ( N - m )}{N \times Dusr}$$

Since it is necessary to complete decoding the difference frame Pm by the time at which the difference frame Pm is displayed next to the reference frame I2, the following formula 3 should hold:
Td≦Tp Formula 3
Accordingly, the following formula 4 is obtained on the basis of the formulas 1 through 3:

$$Formula 4 \text{:}$$

$$Td = \frac{T \times m}{N \times D max} ≦ Tp = \frac{T \times ( N - m )}{N \times Dusr}$$

On the basis of the formula 4, the limit number m of the difference frames is represented by the following formula 5:

$$Formula 5 \text{:}$$

$$m ≦ \frac{N \times Dmax}{Dmax + Dusr}$$

In this manner, the limit number m of the difference frames that can be decoded in the rewind reproducing processing is calculated.

[Step ST15]

Next, the CPU 12 selects at least one difference frame Px present in the range of the limit number m calculated in step ST14 (namely, P≦Px≦Pm) (see FIG. 7).

[Step ST16]

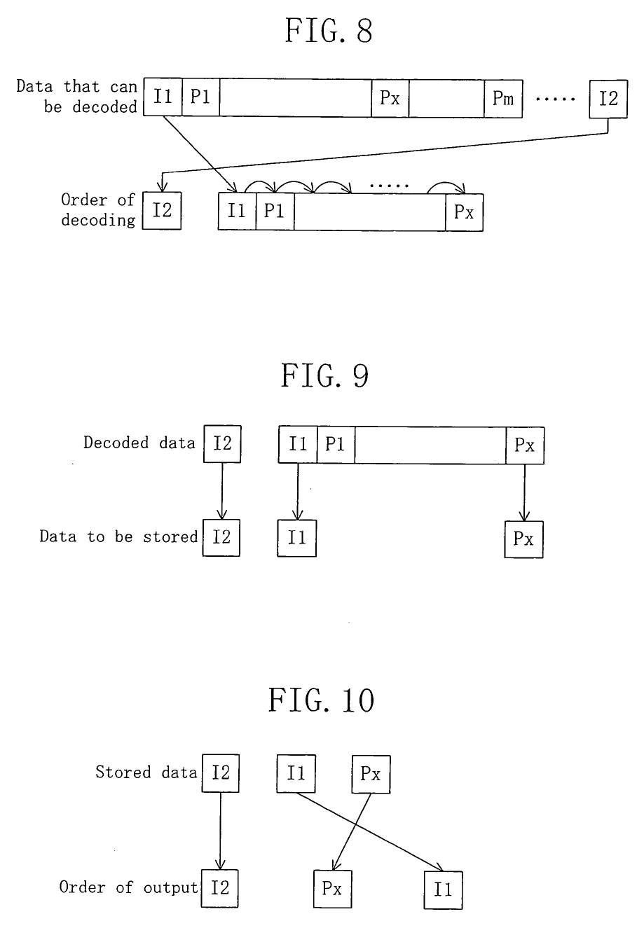

Then, the CPU 12 decodes the encoded dynamic image data stored in the storage memory 13. As shown in FIG. 8, with respect to reference frames, all are decoded, but with respect to difference frames, those present from the reference frame P1 to the reference frame Px selected in step ST15 are decoded.

[Step ST17]

Next, the CPU 12 stores, as shown in FIG. 9, the decoded data of the reference frames and the decoded data of the difference frame Px selected in step ST15 in the frame buffer 14.

[Step ST18]

Next, the input/output interface 15 outputs the decoded data stored in the frame buffer 14 to the display device 2. At this point, the input/output interface 15 outputs the decoded data in the descending order of the display times by referring to the display timing information included in the frame information acquired in step ST3 and the forward/reverse reproduction speed information 200. Herein, as shown in FIG. 10, the decoded data of the reference frame I2, the decoded data of the difference frame Px and the decoded data of the reference frame I1 are output in this order.

Now, the procedures from step ST11 to step ST18 will be described by using a specific example.

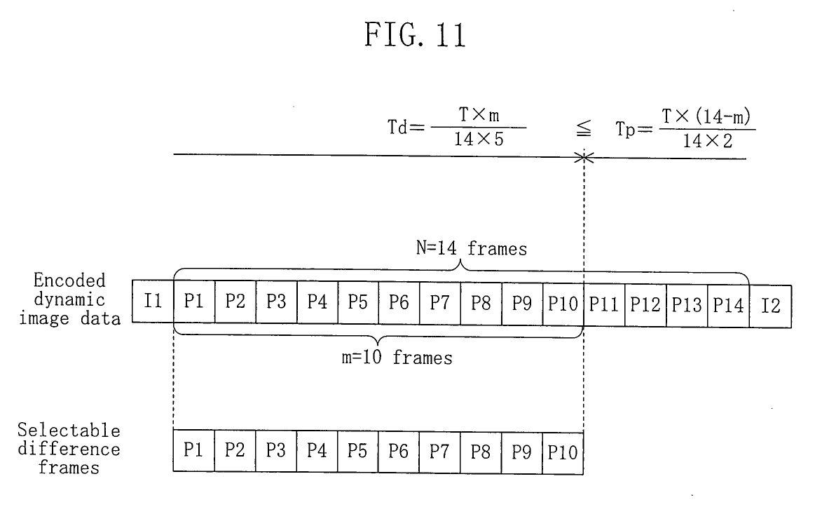

First, in the procedures of steps ST11 through ST13, it is assumed, as shown in FIG. 11, that the scale factor Dmax of the possible maximum decoding speed against the decoding speed employed in the ordinary reproducing processing of the dynamic image decoding device 1 is set to five times (Dmax=5), that the scale factor Dusr of the rewind reproduction speed specified by a user against the standard reproduction speed is set to twice (Dusr=2), and that the number N of difference frames present between the reference frames is set to fourteen (N=14).

Next, in step ST14, the following formula 6 is obtained by substituting the aforementioned values in the formula 5:

$$Formula 6 \text{:}$$

$$m ≦ \frac{14 \times 5}{5 + 2} = 10$$

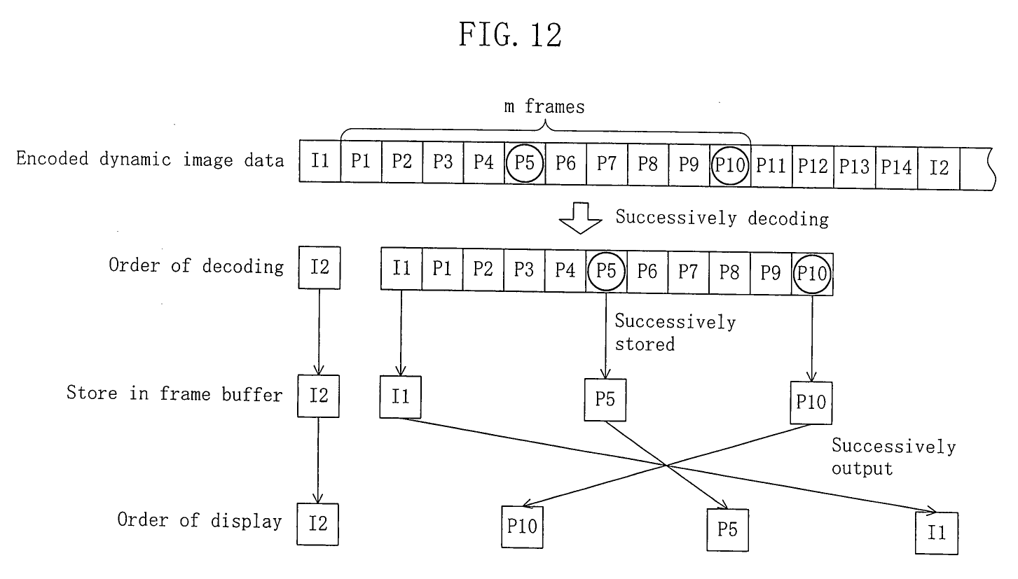

On the basis of the formula 6, the limit number m of difference frames that can be decoded in the rewind reproducing processing is ten (m=10) as shown in FIG. 11. In other words, the decoding can be performed on difference images up to the tenth difference image (namely, the difference frame P10). Also, since the number of difference images present between the reference images is fourteen, the number of difference images not to be displayed is four (namely, the difference frames P11 through P14). In the dynamic image decoding, smoother display can be produced when the number of difference images not to be displayed is constant. Therefore, the CPU 12 selects difference frames by referring to the frame positions and the display times of the frame information, so that difference images disposed at a constant interval can be displayed. Herein, as shown in FIG. 12, the CPU 12 selects difference frames P5 and P10 from the ten frames selectable in step ST15.

Then, in step ST16, the reference frame I2 and the reference frame I1 are decoded in this order. Next, the difference frames P1 through P10 are decoded on the basis of the reference frame I1.

Subsequently, in step ST17, out of the frame data decoded in step ST16, the decoded data of the reference frame I2, the decoded data of the reference frame I1 and the decoded data of the difference frames P5 and P10 selected in step ST15 are stored in the frame buffer 14.

Next, in step ST18, by referring to the display timing information included in the frame information acquired in step ST3 and the forward/reverse reproduction speed information 200, the decoded data of the reference frame I2, the decoded data of the difference frame P10, the decoded data of the difference frame P5 and the decoded data of the reference frame I1 are output in this order to the display device 2.

In this manner, according to Embodiment 1, in the rewind reproducing processing, not only reference frames alone are decoded but also at least one of difference frames present between the reference frames is decoded to be displayed between the reference frames. Therefore, the number of frames to be displayed in the rewind reproducing processing is increased, resulting in producing smooth rewind reproduced display.

In the procedures of step ST11 through step ST13 performed in the rewind reproducing processing, the scale factor Dmax of the possible maximum decoding speed against the decoding speed employed in the ordinary reproducing processing of the dynamic image decoding device 1 is acquired to be used for calculating the limit number m. Thus, the limit number m can be maximized. A value smaller than the maximum scale factor Dmax may be used instead of the maximum scale factor Dmax for calculating the limit number m. However, when the limit number m is thus calculated, it is smaller than that calculated by using the maximum scale factor Dmax.

Also, in the rewind reproducing processing, the difference frames P5 and P10 are selected as the example in step ST15 because smoother rewind reproduced display can be produced when the interval of frames to be displayed is constant.

### EMBODIMENT 2

The whole architecture of a dynamic image reproducing system according to Embodiment 2 is the same as that shown in FIG. 1 but this dynamic image reproducing system is different from that of Embodiment 1 in the operation of the CPU 12.

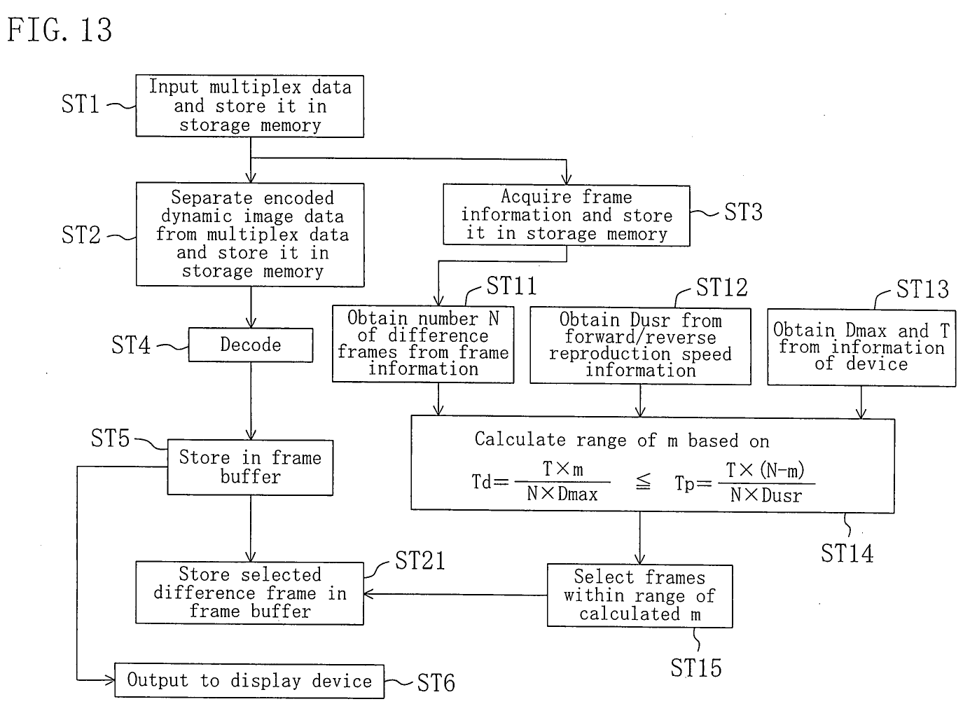

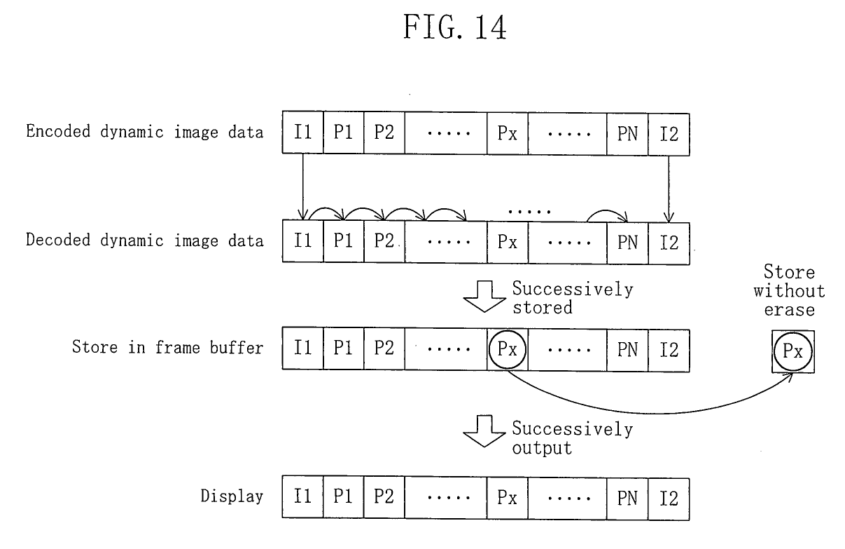

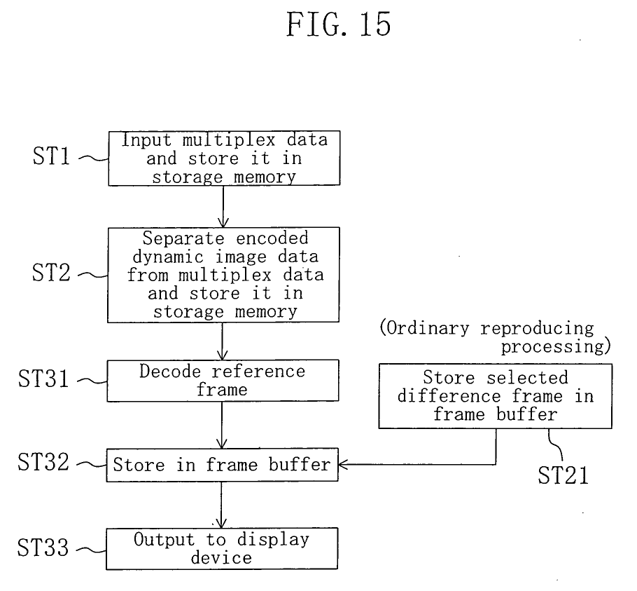

Now, ordinary reproducing processing performed in the dynamic image reproducing system of Embodiment 2 will be described with reference to FIGS. 13 and 14.

[Ordinary Reproducing Processing]

[Steps ST1 through ST5]

The procedures of steps ST1 through ST5 of the ordinary reproducing processing are performed in the same manner as in Embodiment 1 so as to store decoded dynamic image data (frame data) in the frame buffer 14.

[Steps ST3 and ST1 through ST15]

Also, the procedures of step ST3 and steps ST11 through ST15 that performed in the rewind reproducing processing in Embodiment 1 are performed so as to select a difference frame Px.

[Step ST21]

Next, the CPU 12 makes the difference frame Px, which is selected in step ST15, remain in the frame buffer 14 out of the frames stored in the frame buffer 14 even after the output from the frame buffer 14. In Embodiment 1, in order to effectively use the memory capacity of the frame buffer 14, the frames stored in the frame buffer 14 are erased from the frame buffer 14 immediately after the output, and thereafter, new frames are stored in the frame buffer 14.

[Step ST6]

Then, the procedure of step ST6 of the ordinary reproducing processing is performed in the same manner as in Embodiment 1. The decoded data of the difference frame Px stored in the frame buffer remains in the frame buffer 14.

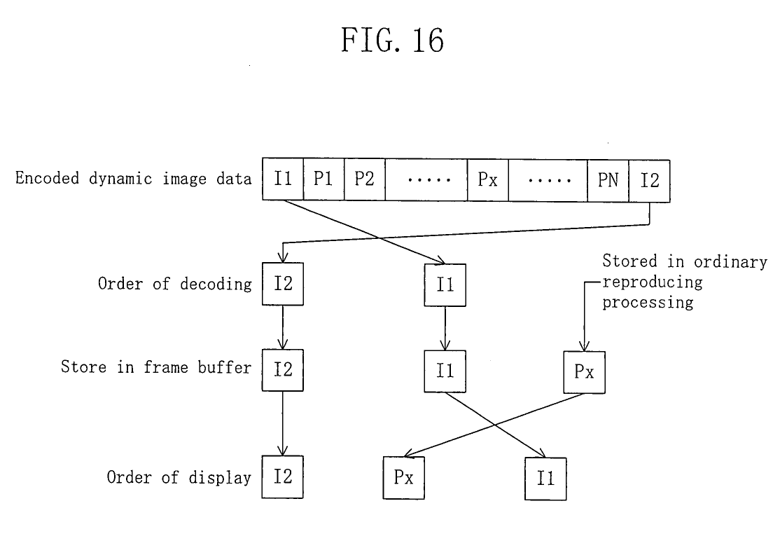

Now, the rewind reproducing processing will be described with reference to FIGS. 15 and 16.

[Rewind Reproducing Processing]

[Steps ST1 and ST2]

The procedures of steps ST1 and ST2 are performed in the same manner as in Embodiment 1.

[Step ST31]

Next, the CPU 12 decodes the reference frames I1 and I2 out of the encoded dynamic image data obtained in step ST2.

[Step ST32]

Then, the CPU 12 stores the decoded data of the reference frames I1 and I2 obtained in step ST31 in the frame buffer 14. The decoded data of the difference frame Px is already stored in the frame buffer 14 in step ST21 (of the ordinary reproducing processing).

[Step ST33]

Next, the input/output interface 15 outputs the decoded data stored in the frame buffer 14 (i.e., the decoded data of the reference frames I1 and I2 and the previously stored decoded data of the difference frame Px) to the display device 2 in the descending order of the display times by referring to the display timing information included in the frame information and the forward/reverse reproduction speed information 200. The display device 2 displays (rewind reproducing displays) the reference frame I2, the difference frame Px and the reference frame I1 in this order on the screen.

In this manner, since the decoded data of the difference frame Px is stored in the frame buffer 14 in the ordinary reproducing processing, there is no need to perform the decoding of the difference frame Px to be displayed in the rewind reproducing processing. Thus, the burden in the processing of the CPU 12 can be reduced as compared with that of Embodiment 1 and simultaneously, the effect attained by Embodiment 1 can be also attained.

### EMBODIMENT 3

The whole architecture of a dynamic image reproducing system according to Embodiment 3 is the same as that shown in FIG. 1, but this dynamic image reproducing system is different from that of Embodiment 1 in the operation of the CPU 12. Also, in Embodiment 3, on the basis of a difference frame stored in the frame buffer in the rewind reproducing processing of Embodiment 2, another difference frame is decoded.

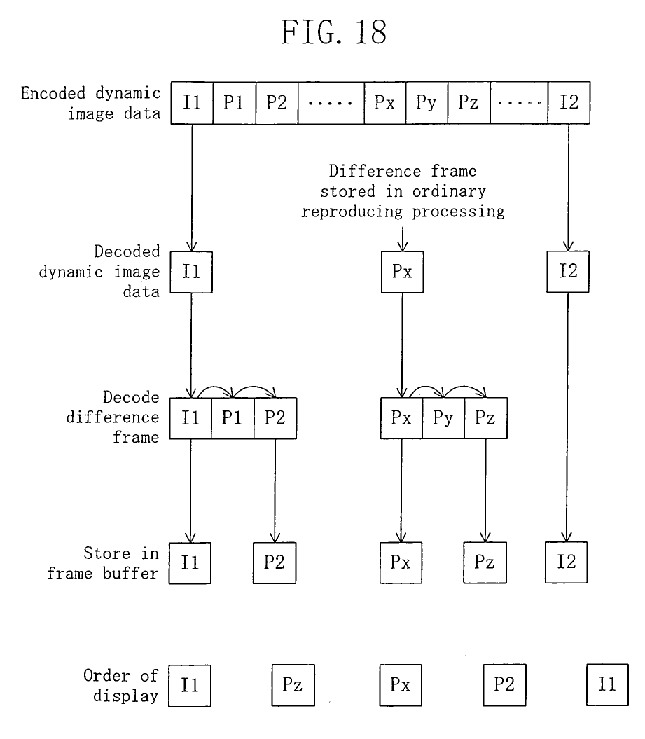

Now, the ordinary reproducing processing performed in the dynamic image reproducing system of Embodiment 3 will be described with reference to FIGS. 13 and 18.

[Ordinary Reproducing Processing]

The same procedures as those of Embodiment 2 are performed so as to store the decoded data of a difference frame Px in the frame buffer 14 in step ST21.

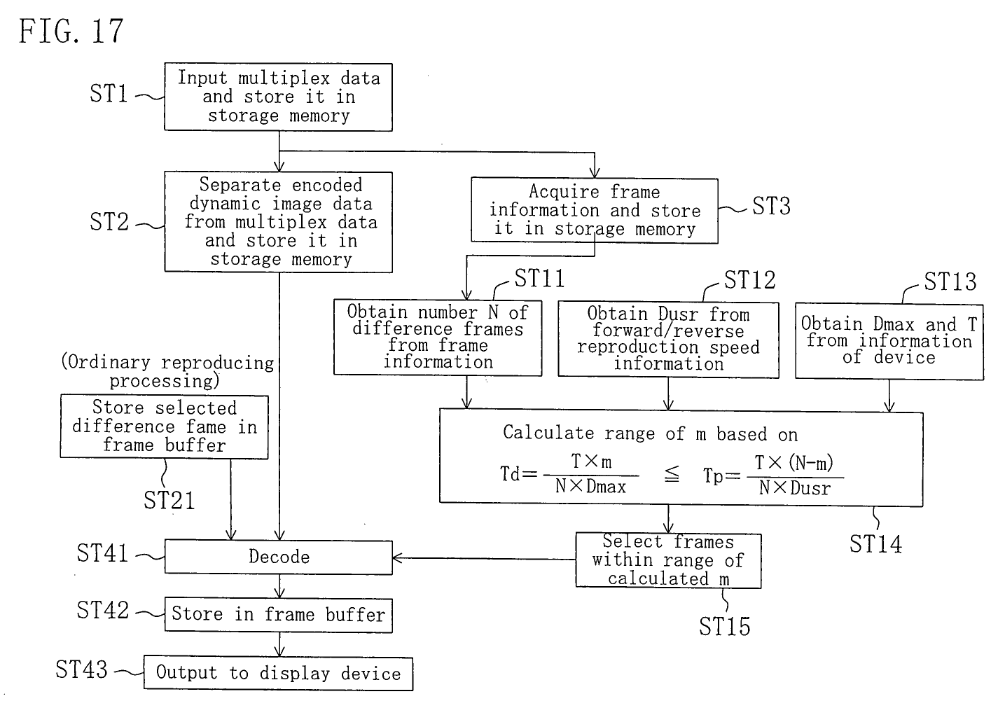

Next, the rewind reproducing processing performed in the dynamic image reproducing system of Embodiment 3 will be described with reference to FIGS. 17 and 18.

[Rewind Reproducing Processing]

[Steps ST1 and ST2]

First, the procedures of steps ST1 and ST2 are performed in the same manner as in Embodiment 1.

[Steps ST3 and ST11 through ST15]

Also, the procedures up to step ST15 are performed in the same manner as in Embodiment 1, so as to select difference frames P2, Px and Pz.

[Step ST41]

Next, the CPU 12 decodes the encoded dynamic image data stored in step ST2. Difference frames decoded at this point are the difference frame P2 decoded on the basis of the reference frame I1 and the difference frame Pz decoded on the basis of the difference frame Px stored in the frame buffer 14. The difference frame Px selected in step ST15 is already decoded to be stored in the frame buffer 14 in step ST21 of the ordinary reproducing processing.

[Step ST42]

Then, the CPU 12 stores the decoded frame data in the frame buffer 14. The decoded data of the reference frames I1 and I2 are all stored, and with respect to the decoded data of the difference frames, the decoded data of merely the difference frames P2, Px and Pz selected in step ST15 are stored.

[Step ST43]

Subsequently, the input/output interface 15 outputs, to the display device 2, the frame data stored in the frame buffer 14 in the order of the reference frame I2, the difference frame Pz, the difference frame Px, the difference frame P2 and the reference frame I1 by referring to the display timing information included in the frame information and the forward/reverse reproduction speed information 200.

In this manner, since the difference frames Pz and P2 are decoded on the basis of the difference frame Px and the reference frame I1 stored in the frame buffer 14 in the ordinary reproducing processing, even when the same number of difference frames are stored in the frame buffer 14 in the ordinary reproducing processing as in Embodiment 2, the number of frames to be displayed is increased (specifically, the number is increased correspondingly to the difference frames P2 and Pz in the above description). Therefore, smoother rewind reproduced display can be produced than in Embodiment 2. Furthermore, even when the number of frames to be displayed is the same as that in Embodiment 2, the memory capacity necessary for the frame buffer 14 can be reduced because the number of difference frames to be stored in the frame buffer 14 is reduced. For example, in the above-described case, it is necessary to store the three difference frames P2, Px and Pz in the frame buffer 14 in the ordinary reproducing processing of Embodiment 2. In contrast, merely one difference frame Px is stored in Embodiment 3.

### EMBODIMENT 4

The whole architecture of a dynamic image reproducing system according to Embodiment 4 is the same as that of Embodiment 1 shown in FIG. 1 but this dynamic Embodiment 4 is the same as that of Embodiment 1 shown in FIG. 1 but this dynamic image reproducing system is different from that of Embodiment 1 in the operation of the CPU 12. Also, in Embodiment 4, while rewind reproduced display is being produced by using the difference frames stored in the frame buffer 14 in the rewind reproducing processing of Embodiment 2, processing for decoding a difference frame necessary for next display is performed in parallel.

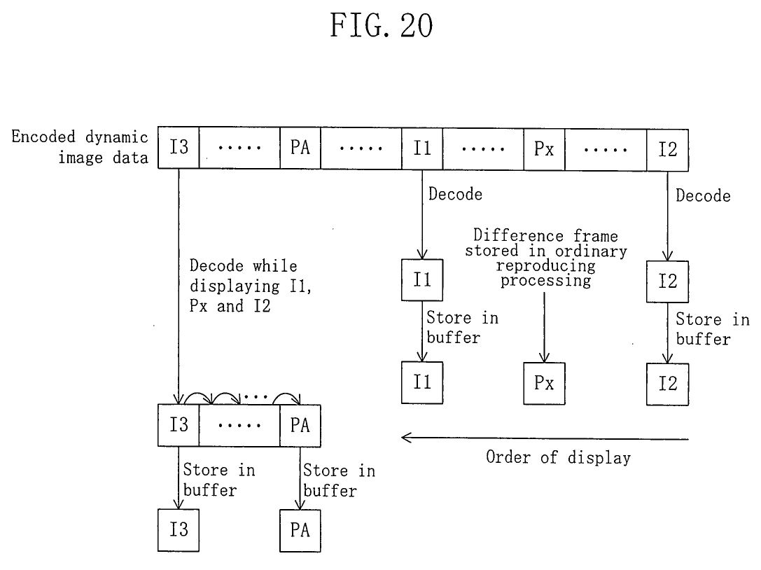

Now, the ordinary reproducing processing performed in the dynamic image reproducing system of Embodiment 4 will be described with reference to FIGS. 13 and 20.

[Ordinary Reproducing Processing]

The same procedures as those of Embodiment 2 are performed so as to store a difference frame Px in the frame buffer 14 in step ST21.

Next, the rewind reproducing processing performed in the dynamic image reproducing system of Embodiment 4 will be described with reference to FIGS. 15, 19 and 20.

[Rewind Reproducing Processing]

The procedures of steps ST1, ST2, ST31, ST21, ST32 and ST33 (shown in FIG. 15) are performed in the same manner as in Embodiment 2 so as to output a reference frame I2, the difference frame Px and a reference frame I1 to the display device 2 successively in this order.

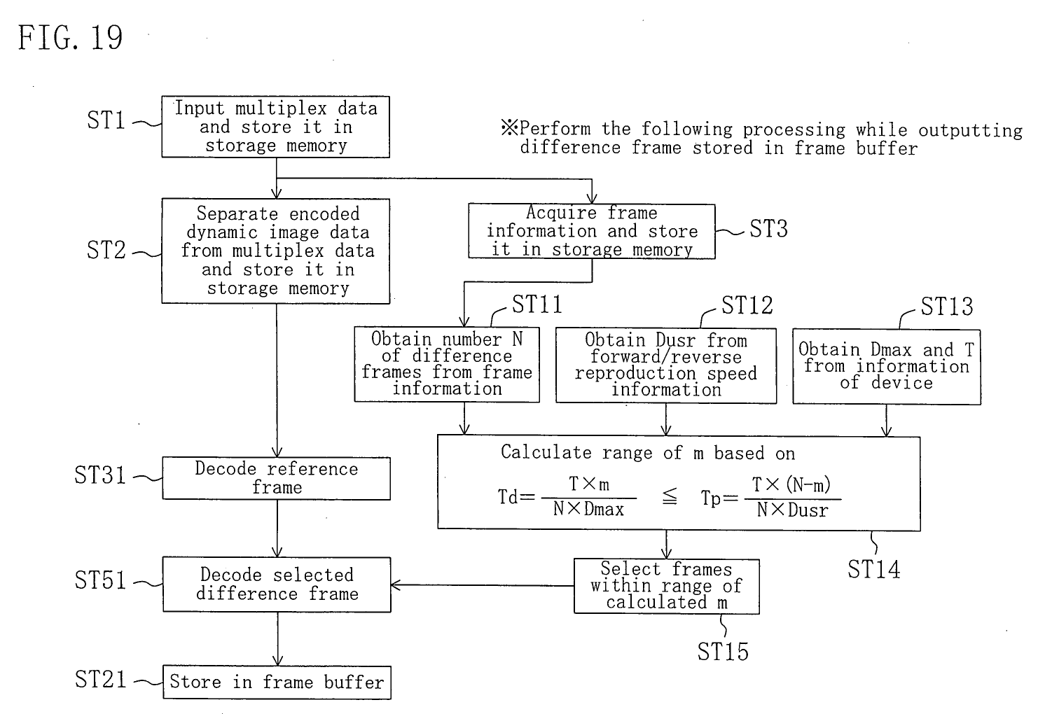

On the other hand, the following processing (shown in FIG. 19) is performed in parallel.

[Steps ST1, ST2 and ST31]

First, the procedures of steps ST1, ST2 and ST31 are performed in the same manner as in Embodiment 2 so as to decode a reference frame I3.

[Steps ST3 and ST1 through ST15]

Furthermore, the procedures up to step ST15 are performed in the same manner as in Embodiment 2 so as to select a difference frame PA.

[Step ST51]

Next, the CPU 12 decodes the difference frame PA selected in step ST15 on the basis of the reference frame I3 decoded in step ST31.

[Step ST21]

Then, the CPU 12 stores, in the frame buffer 14, the decoded data of the reference frame I3 obtained in step ST31 and the decoded data of the difference frame PA selected in step ST15 out of decoded difference frames.

The aforementioned procedures are carried out in parallel to the output to the display device 2. In other words, the aforementioned processing is carried out during the rewind reproducing processing of Embodiment 2 (shown in FIG. 15).

In this manner, while the reference frame I2, the difference frame Px and the reference frame I1 are being output to the display device 2, the reference frame I3 and the difference frame PA are decoded and stored in the frame buffer 14.

Also, step ST33 of the former processing (shown in FIG. 15) is performed as follows:

[Step ST33]

In step ST33, after outputting the reference frame I2, the difference frame Px and the reference frame I1 to the display device 2, the input/output interface 15 outputs the newly stored decoded dynamic image data (namely, the reference frame I3 and the difference frame PA in this case) in the descending order of the display times (namely, in the order of the difference frame PA and the reference frame I3 after the reference frame I1) by referring to the display timing information included in the frame information and the forward/reverse reproduction speed information 200.

In this manner, since a difference frame necessary for next display is decoded while frames stored in the frame buffer 14 are being output, the number of difference frames stored in the frame buffer 14 can be reduced, and hence, the memory capacity of the frame buffer 14 can be smaller than in Embodiment 2.

### EMBODIMENT 5

The whole architecture of a dynamic image reproducing system according to Embodiment 5 is the same as that of Embodiment 1 shown in FIG. 1, but this dynamic image reproducing system is different from that of Embodiment 1 in the operation of the CPU 12. In Embodiment 5, in storing a difference frame in the frame buffer 14 in the ordinary reproducing processing, the resolution of the difference frame is lowered, and the difference frame with the lowered resolution is expanded to be output to the display device 2 in the rewind reproducing processing.

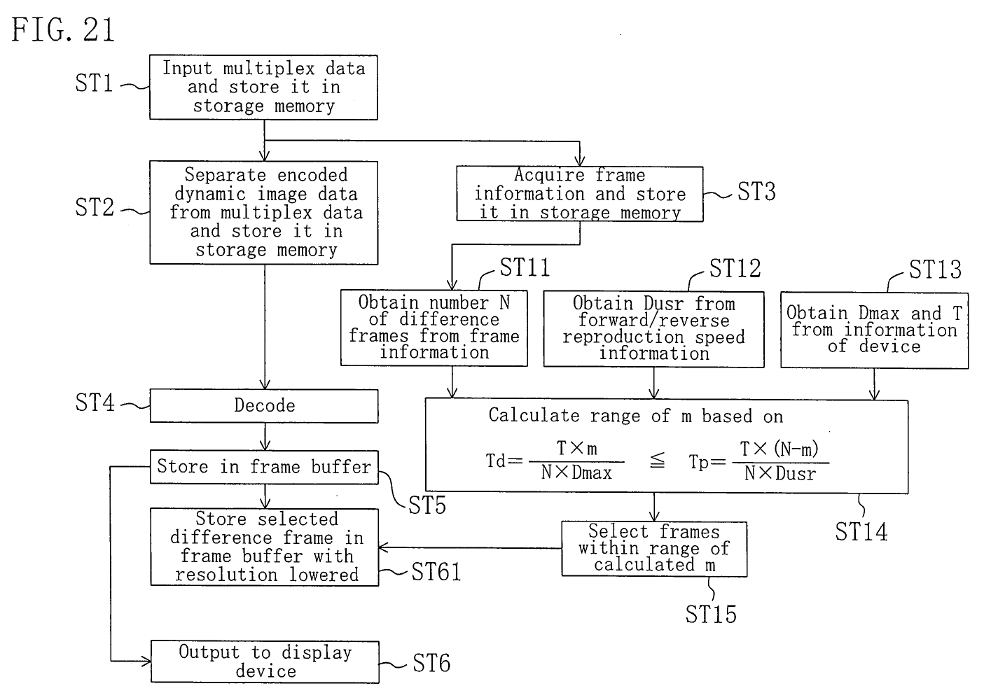

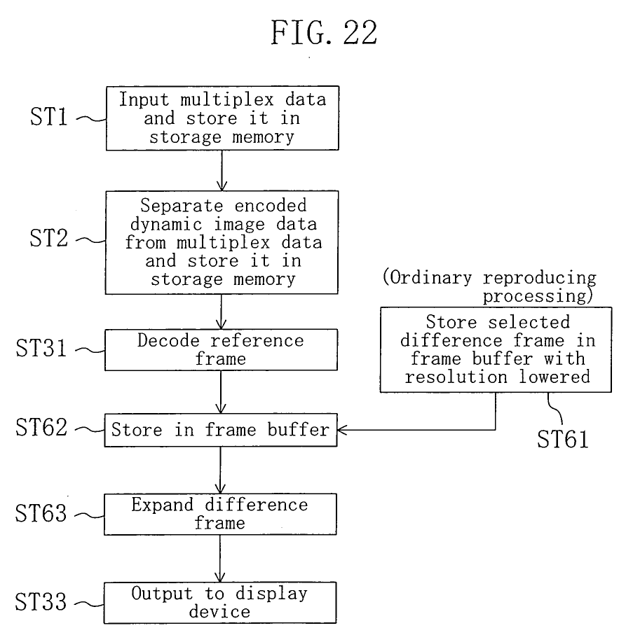

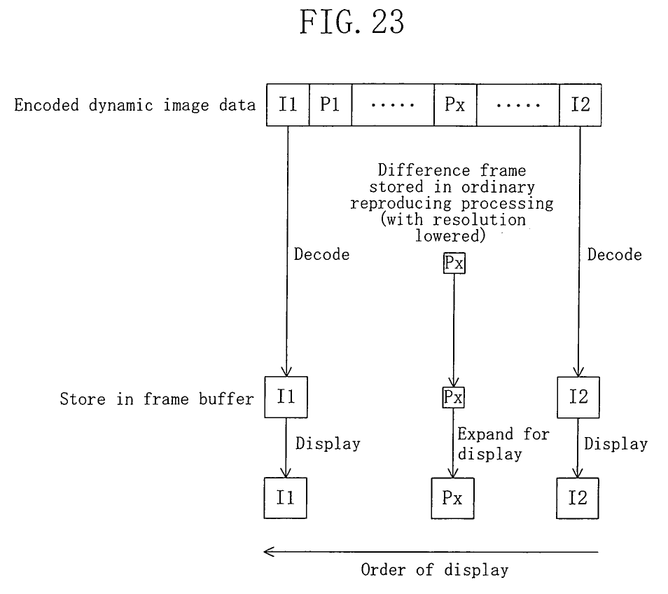

Now, the ordinary reproducing processing performed in the dynamic image reproducing system of Embodiment 5 will be described with reference to FIGS. 21 and 23.

[Ordinary Reproducing Processing]

[Steps ST1 through ST5]

First, the procedures of steps ST1 through ST5 of the ordinary reproducing processing are performed in the same manner as in Embodiment 2 so as to store decoded dynamic image data in the frame buffer 14.

[Steps ST3 and ST11 through ST15]

Furthermore, the procedures up to step ST15 are performed in the same manner as in Embodiment 2 so as to select a difference frame Px.

[Step ST61]

Next, the CPU 12 makes the difference frame Px selected in step ST15 remain in the frame buffer 14 even after the output of the frames stored in the frame buffer 14. In storing the difference frame Px in the frame buffer 14, the resolution of the difference frame Px is lowered.

[Step ST6]

Then, the procedure of step ST6 is performed in the same manner as in Embodiment 2. At this point, the difference frame Px selected in step ST15 alone remains in the frame buffer 14.

Next, the rewind reproducing processing performed in the dynamic image reproducing system of Embodiment 5 will be described with reference to FIGS. 22 and 23.

[Rewind Reproducing Processing]

[Steps ST1, ST2 and ST31]

First, the procedures of steps ST1, ST2 and ST31 are performed in the same manner as in Embodiment 2 so as to decode reference frames I2 and I1.

[Step ST62]

Next, the decoded data of the reference frames I2 and I1 obtained in step ST31 is stored in the frame buffer 14. The frame buffer 14 already stores the decoded data (with lowered resolution) of the difference frame Px in step ST61 (of the ordinary reproducing processing).

[Step ST63]

Then, the CPU 12 expands the decoded data of the difference frame Px stored in the frame buffer 14.

[Step ST33]

Next, the decoded dynamic image data stored in the frame buffer 14 (namely, the decoded data of the reference frames I2 and I1 and the difference frame Px in this case) are output in the descending order of the display times (namely, in the order of the reference frame I2, the difference frame Px and the reference frame I1) by referring to the display timing information included in the frame information and the forward/reverse reproduction speed information 200. With respect to the difference frame Px, the data expanded in step ST63 is output.

In this manner, since the resolution of a difference frame is lowered in storing it in the frame buffer in the ordinary reproducing processing, a larger number of difference frames can be stored in the frame buffer 14 than in Embodiment 2 (in the case where the frame buffer 14 has the same memory capacity). The resultant display produced in the display device 2 is disturbed because expanded data of the difference frame with lower resolution is displayed, but a frame desired by a user can be more highly possibly displayed in the rewind reproducing processing because the number of frames to be displayed is increased. Accordingly, the user can more easily retrieve a desired scene of the dynamic image.

### EMBODIMENT 6

The whole architecture of a dynamic image reproducing system according to Embodiment 6 is the same as that of Embodiment 1 shown in FIG. 1, but this dynamic image reproducing system is different from that of Embodiment 1 in the operation of the CPU 12. In Embodiment 6, in storing a difference frame in the frame buffer 14, the resolution of the difference frame is lowered, and in the rewind reproducing processing, another difference frame is decoded on the basis of the difference frame with the lowered resolution stored in the frame buffer 14 and the difference frames with the lowered resolution are expanded to be output to the display device 2.

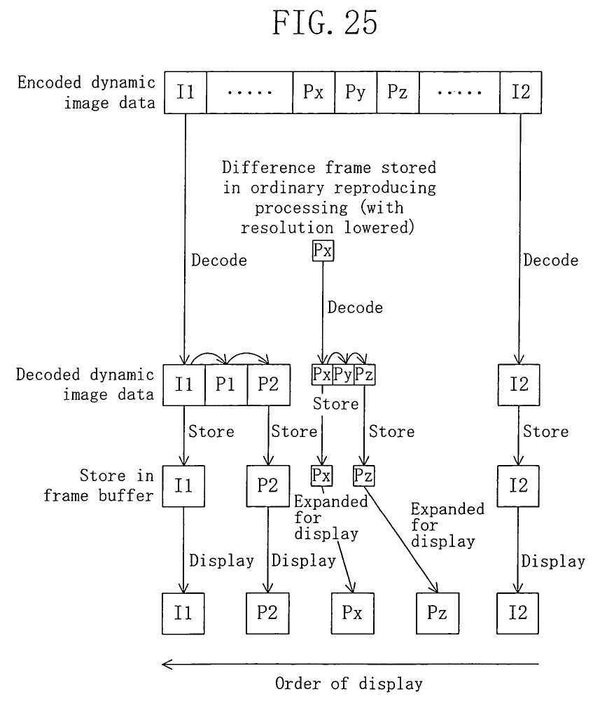

Now, the ordinary reproducing processing performed in the dynamic image reproducing system of Embodiment 6 will be described with reference to FIGS. 21 and 25.

[Ordinary Reproducing Processing]

The same procedures as those performed in Embodiment 5 are carried out so as to store decoded data (with lowered resolution) of a difference frame Px in the frame buffer 14 in step ST61.

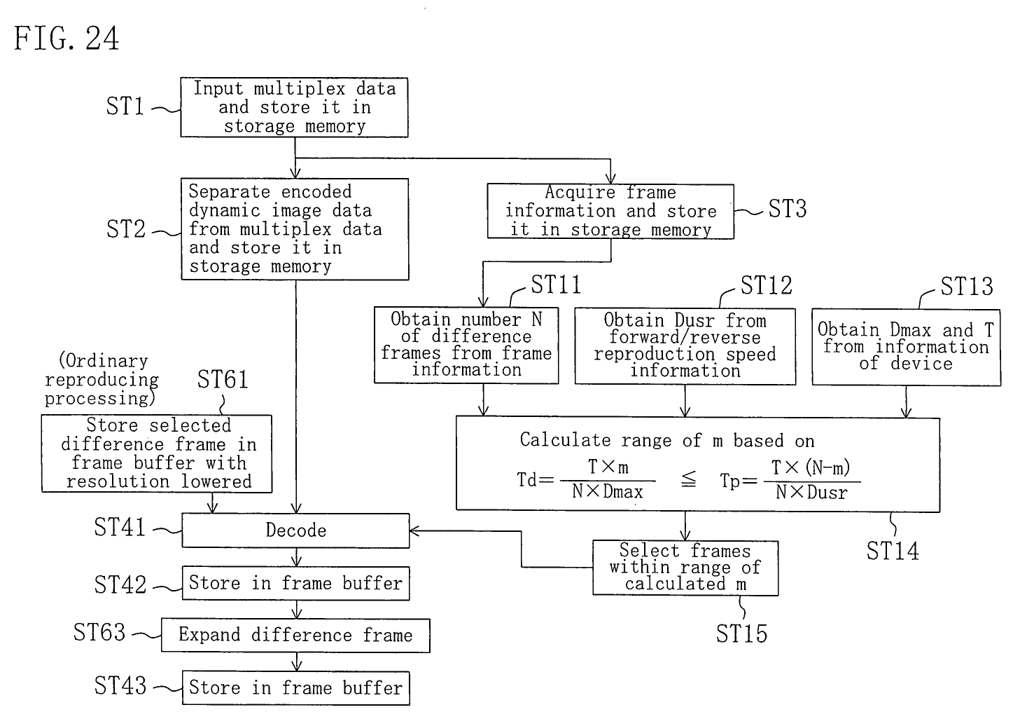

Next, the rewind reproducing processing performed in the dynamic image reproducing system of Embodiment 6 will be described with reference to FIGS. 24 and 25.

[Rewind Reproducing Processing]

[Steps ST1 and ST2]

First, the procedures of steps ST1 and ST2 are performed in the same manner as in Embodiment 3.

[Steps ST3 and ST11 through ST15]

Furthermore, the procedures up to step ST15 are performed in the same manner as in Embodiment 3 so as to select difference frames P2, Px and Pz.

[Step ST41]

The procedure of step ST41 is performed in the same manner as in Embodiment 3, so as to decode reference frames I2 and I1 out of the encoded dynamic image data stored in step ST2, and decode the difference frame P2 selected in step ST15 on the basis of the decoded reference frame I1. Also, the CPU 12 decodes the difference frame Pz selected in step ST15 on the basis of the decoded difference frame Px stored in the frame buffer 14 in step ST61 (of the ordinary reproducing processing). In other words, difference frames decoded at this point are the difference frame P2 decoded on the basis of the reference frame I1 and the difference frame Pz decoded on the basis of the decoded difference frame Px with the lowered resolution.

[Step ST42]

Next, the procedure of step ST42 is performed in the same manner as in Embodiment 3 so as to store, in the frame buffer 14, the decoded reference frames I2 and I1, the difference frame P2 decoded on the basis of the reference frame I1 and the difference frame Pz decoded on the basis of the decoded difference frame Px with the lowered resolution. The difference frame Px is already stored in the frame buffer 14 in the ordinary reproducing processing.

[Step ST63]

Next, the procedure of step ST63 is performed in the same manner as in Embodiment 5 so as to expand the decoded difference frames Px and Pz with the lowered resolution. In other words, the decoded difference frame Px stored in the frame buffer 14 in the ordinary reproducing processing and the difference frame Pz decoded on the basis of the decoded difference frame Px are expanded.

[Step ST43]

Then, the procedure of step ST43 is performed in the same manner as in Embodiment 3 so as to output, to the display device 2, the decoded dynamic image data stored in the frame buffer 14 in the descending order of the display times (namely, in the order of the reference frame I2, the difference frame Pz, the difference frame Px, the difference frame P2 and the reference frame I1) by referring to the display timing information included in the frame information and the forward/reverse reproduction speed information 200.

In this manner, since a difference frame is stored in the frame buffer 14 with its resolution lowered and another difference frame is decoded on the basis of the difference frame stored in the frame buffer 14 in the rewind reproducing processing, the number of frames to be displayed is larger than in Embodiment 5 even when the number of difference frames stored in the frame buffer is the same as that in Embodiment 5, and therefore, smoother rewind reproduced display can be produced than in Embodiment 5. Moreover, even when the number of frames to be displayed is the same as that in Embodiment 5, the number of difference frames stored in the frame buffer 14 is reduced, and hence, the memory capacity necessary for the frame buffer 14 can be reduced.

Furthermore, as compared with Embodiment 3, since a difference frame with lowered resolution is stored in the frame buffer 14, the number of difference frames that can be stored with the same memory capacity can be increased.

### EMBODIMENT 7

The whole architecture of a dynamic image reproducing system according to Embodiment 7 is the same as that of Embodiment 1 shown in FIG. 1, but this dynamic image reproducing system is different from that of Embodiment 1 in the operation of the CPU 12. In Embodiment 7, in storing a difference frame in the frame buffer 14 in accordance with Embodiment 3, the resolution of the difference frame is lowered, and in the rewind reproducing processing, the difference frame with the lowered resolution stored in the frame buffer 14 is expanded, and another difference frame is decoded on the basis of the expanded difference frame to be output to the display device 2.

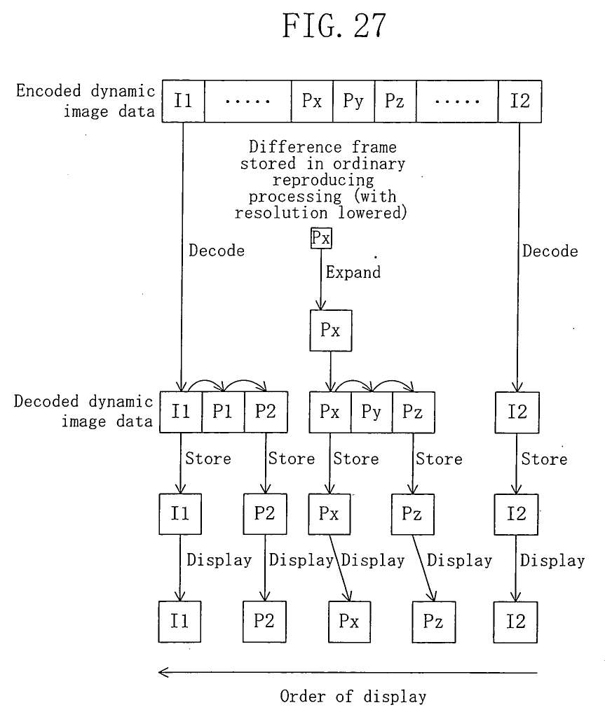

Now, the ordinary reproducing processing performed in the dynamic image reproducing system of Embodiment 7 will be described with reference to FIGS. 21 and 27.

[Ordinary Reproducing Processing]

The same procedures as those of Embodiment 5 are performed so as to store decoded data (with the lowered resolution) of a difference frame Px in the frame buffer 14 in step ST61.

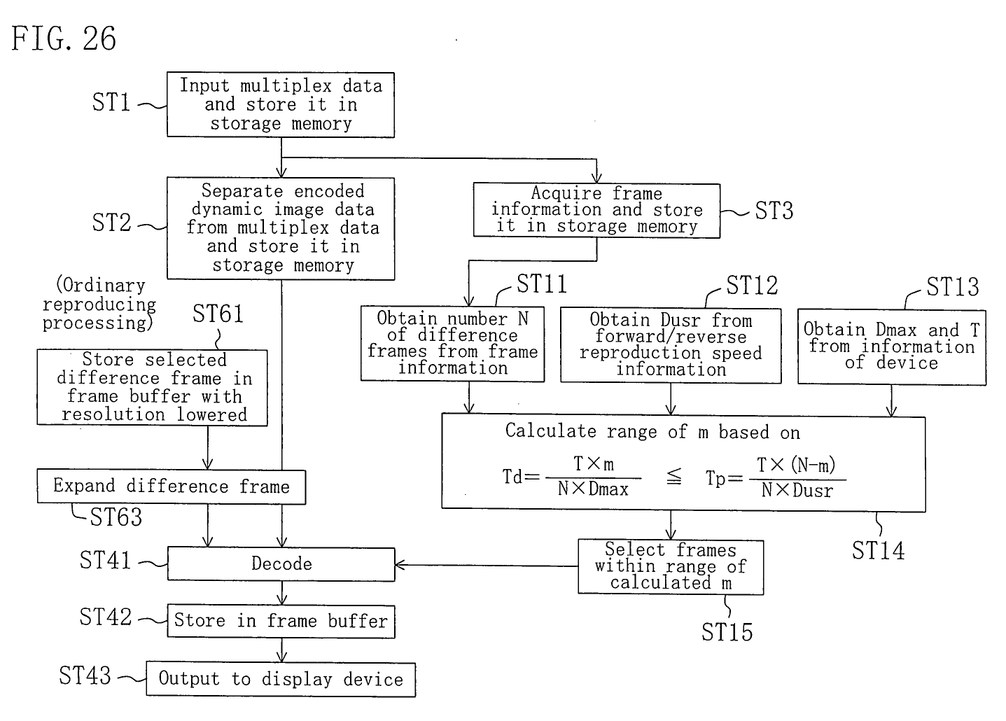

Next, the rewind reproducing processing performed in the dynamic image reproducing system of Embodiment 7 will be described with reference to FIGS. 26 and 27.

[Rewind Reproducing Processing]

[Steps ST1 and ST2]

First, the procedures of steps ST1 and ST2 are performed in the same manner as in Embodiment 3.

[Steps ST3 and ST1 through ST15]

Furthermore, the procedures up to step ST15 are performed in the same manner as in Embodiment 1 so as to select difference frames P2, Px and Pz.

[Step ST63]

Also, the procedure of step ST63 is performed in the same manner as in Embodiment 5 so as to expand the decoded difference frame Px with the lowered resolution stored in step ST61 (of the ordinary reproducing processing).

[Step ST41]

Next, the procedure of step ST41 is performed in the same manner as in Embodiment 3 so as to decode reference frames I2 and I1 out of the encoded dynamic image data stored in step ST2 and to decode the difference frame P2 selected in step ST15 on the basis of the decoded reference frame I1. Also, the CPU 12 decodes the difference frame Pz selected in step ST15 on the basis of the decoded difference frame Px expanded in step ST63. In other words, difference frames decoded at this point are the difference frame P2 decoded on the basis of the reference frame I1 and the difference frame Pz decoded on the basis of the expanded decoded difference frame Px.

[Step ST42]

Next, the procedure of step ST42 is performed in the same manner as in Embodiment 3 so as to store, in the frame buffer 14, the decoded reference frames I2 and I1, the difference frame P2 decoded on the basis of the reference frame I1 and the difference frame Pz decoded on the basis of the expanded decoded difference frame Px. The difference frame Px is already stored in the frame buffer 14 in the ordinary reproducing processing.

[Step ST43]

Then, the procedure of step ST43 is performed in the same manner as in Embodiment 3 so as to output the decoded dynamic image data in the descending order of the display times (namely, in the order of the reference frame I2, the difference frame Pz, the difference frame Px, the difference frame P2 and the reference frame I1) by referring to the display timing information included in the frame information and the forward/reverse reproduction speed information 200.

In this manner, a difference frame with lowered resolution is stored in the frame buffer 14 and another difference frame is decoded on the basis of the difference frame stored in the frame buffer 14 in the rewind reproducing processing. Therefore, even when the number of difference frames stored in the frame buffer 14 is the same as that in Embodiment 5, the number of frames to be displayed is increased, and hence, smoother rewind reproduced display can be produced than in Embodiment 5. Also, even when the number of frames to be displayed is the same as that in Embodiment 5, the number of difference frames to be stored in the frame buffer 14 is reduced, and hence, the memory capacity necessary for the frame buffer 14 can be reduced.

Furthermore, as compared with Embodiment 3, since a difference frame with lowered resolution is stored in the frame buffer 14, the number of difference frames that can be stored with the same memory capacity can be increased.

### EMBODIMENT 8

The whole architecture of a dynamic image reproducing system of Embodiment 8 is the same as that of Embodiment 1 shown in FIG. 1, but this dynamic image reproducing system is different from that of Embodiment 1 in the operation of the CPU 12. In Embodiment 8, during the processing performed in accordance with any of Embodiments 5 through 7, when a user makes an instruction to interrupt special reproducing processing (herein, the rewind reproducing processing), the ordinary reproducing processing is performed with a difference frame currently displayed with lowered resolution replaced with a difference frame with the original resolution.

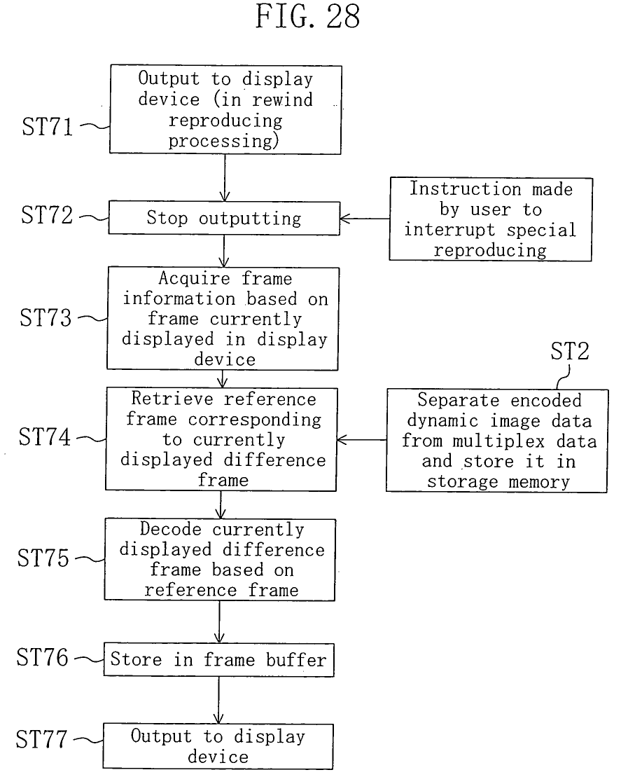

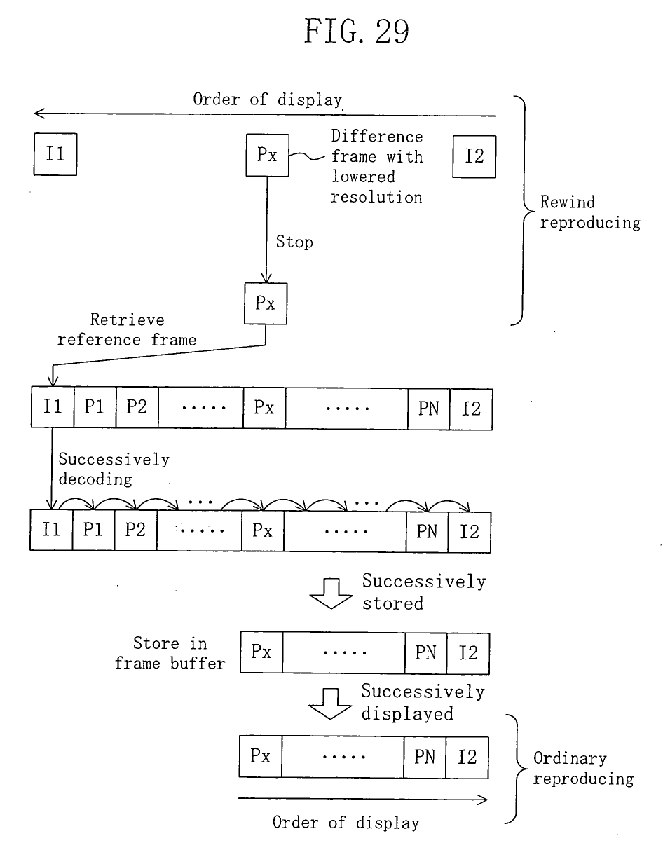

Now, switching processing from the rewind reproducing processing to the ordinary reproducing processing performed in the dynamic image reproducing system of Embodiment 8 will be described with reference to FIGS. 28 and 29.

[Switching Processing]

[Step ST71]

First, the input/output interface 15 outputs data for the rewind reproducing processing. In this case, a difference frame with lowered resolution is displayed between reference frames.

[Step ST72]

Next, a user makes an instruction to interrupt the special reproducing (the rewind reproducing) processing. In response to the instruction, the input/output interface 15 stops outputting the decoded dynamic image data.

[Step ST73]

Then, the CPU 12 acquires the frame information of a frame currently displayed on the display device 2.

[Step ST74]

Subsequently, the CPU 12 retrieves, from the encoded dynamic image data stored in the storage memory 13 in step ST2, a reference frame on the basis of which the difference frame is obtained by referring to the frame information acquired in step ST73.

[Step ST75]

Next, the CPU 12 successively decodes difference frames on the basis of the reference frame retrieved in step ST74.

[Step ST76]

Then, the CPU 12 successively stores, in the frame buffer 14, frames following the currently displayed frame out of the decoded dynamic image data decoded in step ST75.

[Step ST77]

Next, the input/output interface 15 outputs, to the display device 2, the decoded dynamic image data stored in step ST76 in the ascending order of the display times by referring to the display timing information included in the frame information and the forward/reverse reproduction speed information 200.

In this manner, when a frame displayed at the interruption of the special reproducing processing is a difference frame with lowered resolution, a reference frame on the basis of which the difference frame is obtained is retrieved from the encoded dynamic image data, and data up to the currently displayed frame is immediately decoded with the original resolution by using the retrieved reference frame. Thus, the ordinary reproducing processing can be performed without disturbing the display.

If difference frames are successively decoded on the basis of a currently displayed decoded difference frame with the lowered resolution without performing such processing, the resolution of the decoded difference frames is also lowered. Therefore, the display may be disturbed until a next reference frame is displayed.

In step ST73, if the currently displayed frame is a reference frame or a difference frame with the resolution not lowered, difference frames are successively decoded from the current frame.

1. A dynamic image decoding device for decoding encoded dynamic image data,
said encoded dynamic image data including frame information; a first reference frame resulting from intraframe prediction coding; a second reference frame resulting from intraframe prediction coding and present ahead of said first reference frame on the time axis; and a plurality of difference frames present between said first reference frame and said second reference frame on the time axis and resulting from interframe prediction coding on the basis of said first reference frame,
said frame information including information of arrangement on the time axis of frames included in said encoded dynamic image data,
said dynamic image decoding device, having an ordinary reproducing mode and a rewind reproducing mode, comprising:
an analysis unit for selecting at least one of said plurality of difference frames;
a decoding unit for decoding said difference frame selected by said analysis unit and said first and second reference frames; and
an output unit for outputting, to a display device, said difference frame, said first reference frame and said second reference frame having been decoded by said decoding unit successively in an order from one present more ahead on the time axis on the basis of said frame information.

2. The dynamic image decoding device of claim 1, further comprising:
a separation unit for separating said encoded dynamic data from AV data in which said encoded dynamic image data is multiplexed in accordance with a given file format.

3. The dynamic image decoding device of claim 2,
wherein said given file format is ASF or MP4.

4. The dynamic image decoding device of claim 1,
wherein said analysis unit selects at least one of difference frames that are able to be decoded on the basis of said first reference frame within timing of output from said output unit to said display device in said rewind reproducing mode.

5. The dynamic image decoding device of claim 1, further comprising a buffer for storing a difference frame having been decoded by said decoding unit,
wherein said output unit outputs, to said display device, said difference frame stored in said buffer and said first and second reference frames having been decoded by said decoding unit successively in the order from one present more ahead on the time axis on the basis of said frame information in said rewind reproducing mode.

6. The dynamic image decoding device of claim 5,
wherein said decoding unit stores a difference frame selected by said analysis unit out of difference frames decoded in said ordinary reproducing mode.

7. The dynamic image decoding device of claim 6,
wherein said decoding unit decodes a second difference frame on the basis of said difference frame stored in said buffer, and
said output unit outputs, to said display device, said difference frame, said second difference frame and said first and second reference frames having been decoded by said decoding unit and stored in said buffer successively in the order from one present more ahead on the time axis on the basis of said frame information in said rewind reproducing mode.

8. The dynamic image decoding device of claim 7,
wherein said decoding unit stores, in said buffer, said decoded difference frame with resolution thereof lowered, and
said output unit expands said difference frame stored in said buffer and said second difference frame having been decoded by said decoding unit to be output to said display device.

9. The dynamic image decoding device of claim 8,
wherein when said rewind reproducing mode is switched to said ordinary reproducing mode, said decoding unit redecodes a difference frame displayed at mode switching on the basis of a reference frame used correspondingly for decoding said difference frame.

10. The dynamic image decoding device of claim 7,
wherein said decoding unit stores, in said buffer, said decoded difference frame with resolution thereof lowered, expands said difference frame stored in said buffer and decodes another difference frame by using said expanded difference frame.

11. The dynamic image decoding device of claim 10,
wherein when said rewind reproducing mode is switched to said ordinary reproducing mode, said decoding unit redecodes a difference frame displayed at mode switching on the basis of a reference frame used correspondingly for decoding said difference frame.

12. The dynamic image decoding device of claim 5,
wherein said decoding unit decodes a second difference frame on the basis of said difference frame stored in said buffer, and
said output unit outputs, to said display device, said difference frame stored in said buffer, said second difference frame and said first and second reference frames having been decoded by said decoding unit successively in the order from one present more ahead on the time axis on the basis of said frame information in said rewind reproducing mode.

13. The dynamic image decoding device of claim 12,
wherein said decoding unit stores, in said buffer, said decoded difference frame with resolution thereof lowered, and
said output unit expands said difference frame stored in said buffer and said second difference frame having been decoded by said decoding unit to be output to said display device.

14. The dynamic image decoding device of claim 13,
wherein when said rewind reproducing mode is switched to said ordinary reproducing mode, said decoding unit redecodes a difference frame displayed at mode switching on the basis of a reference frame used correspondingly for decoding said difference frame.

15. The dynamic image decoding device of claim 12,
wherein said decoding unit stores, in said buffer, said decoded difference frame with resolution thereof lowered, expands said difference frame stored in said buffer and decodes another difference frame by using said expanded difference frame.

16. The dynamic image decoding device of claim 15,
wherein when said rewind reproducing mode is switched to said ordinary reproducing mode, said decoding unit redecodes a difference frame displayed at mode switching on the basis of a reference frame used correspondingly for decoding said difference frame.

17. The dynamic image decoding device of claim 5,
wherein said encoded dynamic image data further includes:
a third reference frame resulting from intraframe prediction coding and present behind said first reference frame on the time axis; and
a plurality of difference frames present between said third reference frame and said first reference frame on the time axis and resulting from interframe prediction coding on the basis of said third reference frame,
said analysis unit selects at least one of said plurality of difference frames present between said third reference frame and said first reference frame, and
said decoding unit decodes said difference frame having been selected by said analysis unit and present between said third reference frame and said first reference frame in parallel to the output of frames from said output unit to said display device.

18. The dynamic image decoding device of claim 5,
wherein said decoding unit stores, in said buffer, said decoded difference frame with resolution thereof lowered, and
said output unit expands said difference frame stored in said buffer to be output to said display device.

19. The dynamic image decoding device of claim 18,
wherein when said rewind reproducing mode is switched to said ordinary reproducing mode, said decoding unit redecodes a difference frame displayed at mode switching on the basis of a reference frame used correspondingly for decoding said difference frame.
